(19) United States
(12) Patent Application Publication
(10) Pub. No.: US 2005/0022791 A1
(43) Pub. Date: Feb. 3, 2005

(54) Pressure regulating valve for common rail fuel injection systems

(76) Inventors: Christian Braeuer, Ernsthofen (AT); Stefan Holl, Dresden (DE)

Correspondence Address: RONALD E. GREIGG;GREIGG & GREIGG P.L.L.C, 1423 Powhatan Street, Suite One, Alexandria, VA, 22314, US

(21) Appl. No.: 10/898,977

(22) Filed: Jul. 27, 2004

(30) Foreign Application Priority Data
Jul. 29, 2003 (DE) 1 03 34 616.3

(51) Int. Cl. F02M 1/00

(52) U.S. Cl. 123/458

(57) ABSTRACT

A pressure regulating valve for regulating the pressure in a common rail, having a pistonlike valve member guided axially displaceably in a bore, which valve member acts in the closing direction on a closing element and presses it against a valve seat, and the valve member forms an armature of an electromagnet that can be supplied with electric current. The valve is additionally equipped with a mechanical spring, which likewise presses the valve member in the direction of the valve seat, and whose spring constant is designed such that the valve cannot be opened until beyond a predetermined minimum fuel pressure of greater than or equal to 250 bar. In this way, even in the event that the electromagnetic closing force should fail, a minimum pressure at the valve outlet is generated and thus an injection event is made possible.

### BACKGROUND OF THE INVENTION

1. Field of the Invention

The invention relates to a common rail fuel injection system for internal combustion engines, having a pressure regulating valve for regulating the pressure in a common rail, having a pistonlike valve member guided axially displaceably in a bore, which valve member acts in the closing direction on a closing element and presses it against a valve seat, and the valve member forms an armature of an electromagnet that can be supplied with electric current.

2. Description of the Prior Art

Many versions of pressure regulating valves of the type with this invention is concerned are known for regulating the pressure in a common rail. The pressure regulating valve has a pistonlike valve member, which is guided axially displaceably in a bore and can move counter to a force which is exerted on the valve member preferably by the current in an electromagnet. The force acts in the closing direction, so that the valve member is pressed against a closing element of the pressure regulating valve and against a valve seat. The valve member forms an armature of the electromagnet, which can be supplied with current to control the force.

By means of the supply of current, the closing element is pressed via the valve member against the valve seat with a certain force, whereupon as a result of the pressure acting on it the closing element is lifted from the valve seat in the common rail, if the force generated by the pressure exceeds the closing force that is exerted on the closing element via the valve member. If so, fuel flows out of the common rail into a relief chamber via the opened pressure regulating valve.

If a higher pressure is set in the common rail, the current in the electromagnet is increased, thus increasing the closing force, and accordingly only at a higher pressure in the common rail does the closing element lift from the valve seat and allow fuel to flow out of the common rail into the relief chamber.

In addition, the valve is often provided with a mechanical spring, which in its state of repose, that is, while the engine is stopped, assures that the valve is closed and fuel cannot get into the relief chamber. The mechanical spring force of this spring, however, can already easily be overcome by a slight fuel pressure. It is then impossible for a sufficiently high pressure to be built up in the common rail. The requisite minimum pressure in the common rail is assured only by the action of the electromagnetically generated closing force.

If some malfunction in supplying current to the electromagnet occurs, for instance from loosening of the plug involved, causing a failure of the electromagnetic closing force, then fuel at low pressure can get into the relief chamber and make an injection possible. The vehicle can then no longer be driven.

### OBJECT AND SUMMARY OF THE INVENTION

The object of the invention is to improve the pressure regulating valve known from the prior art in such a way that even if the electromagnetic closing force fails, it generates a minimum pressure at the valve outlet and thus makes emergency vehicle operation possible.

This object is attained according to the invention in that the valve is additionally equipped with a mechanical spring, which likewise presses the valve member in the direction of the valve seat and whose spring constant or prestressing is designed such that an injection event by the injector with a fuel quantity sufficient for emergency vehicle operation is possible.

Preferably, the valve cannot open until beyond a predetermined minimum fuel pressure of equal to or greater than to 250 bar. Because of the tensing force or prestressing of the spring, a minimum pressure which is sufficiently high to enable an injection event can build up in the common rail regardless of the effect of the electromagnetic force.

Regulating the injection pressure is done independently of this, by way of the supply of electric current to the electromagnet. However, if the electromagnet should fail because of a malfunction, at least emergency vehicle operation is still possible.

### BRIEF DESCRIPTION OF THE DRAWING

The invention will be better understood and further objects and advantages thereof will become more apparent from the ensuing detailed description of a preferred embodiment taken in conjunction with the single drawing FIGURE which is a section through the pressure regulating valve of the invention along with its disposition relative to the common rail and the fuel tank.

### DESCRIPTION OF THE PREFERRED EMBODIMENT

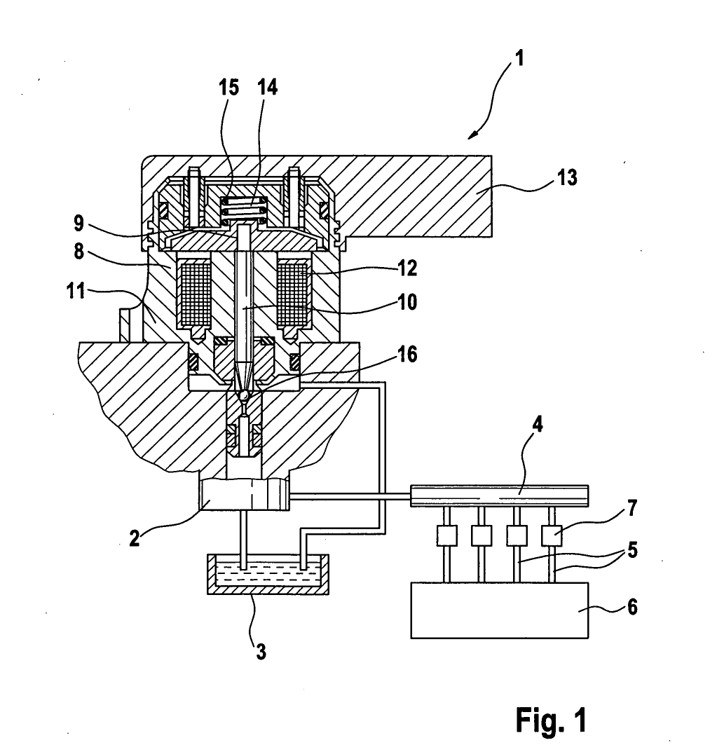

In FIG. 1, a longitudinal section through a pressure regulating valve 1 is shown. Additionally, a common rail fuel injection system for internal combustion engines, in particular self-igniting engines, is shown in schematic form. The common rail fuel injection system has a high-pressure pump 2, by which fuel at high pressure is pumped out of a fuel tank 3 into a common rail 4. The common rail 4 is embodied in tubular form as a so-called rail. From the common rail 4, lines 5 lead to the injection locations of an engine 6, in each of which a valve 7 is disposed; for adjusting the pressure in the common rail 4, the pressure regulating valve is provided, which may be disposed at the outlet of the high-pressure pump 2 or at the common rail 4.

The pressure regulating valve 1 itself has a valve body 8 with a bore 9 in which a pistonlike valve member 10 is disposed axially displaceably. A fastening flange 11 is disposed on the valve body 8, and by way of this flange the valve body is secured to the high-pressure pump 2 or to the common rail 4. In addition, a further chamber inside the valve body 8 is provided, in which an electromagnet 12 with a coil winding is disposed. A connection element 13 is provided on the valve body 8 and covers the chamber of the valve body 8.

According to the invention, a mechanical spring 15, embodied for instance as a helical spring, is provided in a recess 14 in the connection element, with the spring 15 exerting an additional force on the valve member 10 which is sufficient to guarantee closure of the pressure regulating valve 1, as long as the fuel pressure does not exceed a predetermined minimum pressure of preferably greater than 250 bar. Spring 15 also serves the function of the springs employed in the prior art valves of maintaining the valve closed when the engine is not running.

Supplying current to the electromagnet 12 causes the valve member 10 to be pressed farther against the valve seat 16 shown here, so that the lines are correspondingly closed.

Mode of Operation:

If the electromagnet 12 is not supplied with electric current, then both by its own weight and because of the spring action of the mechanical spring 15, the valve member 10 rests on the valve seat 16. The valve seat 16 is simultaneously acted upon by the pressure in the common rail 4.

To make an injection event possible, the pressure in the common rail 4 must attain a minimum level. When the pressure regulating valve 1 is closed, this pressure can build up. If the pressure exceeds a maximum pressure, which can, be regulated by the current in the electromagnet 12, the pressure regulating valve 1 opens, and the fuel can flow into a relief chamber, in this case into the fuel tank 3.

If the electromagnet fails, the force of the mechanical spring 15 (and/or its prestressing) assures that a minimum required pressure can build up in the common rail 4, making an injection event possible, and thus the pressure regulating valve 1, when it is not being supplied with electrical current, will not already open at lesser pressures.

In this way, the injection event and vehicle operation are made possible even if there is a malfunction in supplying current to the electromagnet 12.

The foregoing relates to a preferred exemplary embodiment of the invention, it being understood that other variants and embodiments thereof are possible within the spirit and scope of the invention, the latter being defined by the appended claim.

1. In a pressure regulating valve for regulating the pressure in a common rail, having a pistonlike valve member guided axially displaceably in a bore, which valve member acts in the closing direction on a closing element and presses it against a valve seat (16), and the valve member forming an armature of an electromagnet that can be supplied with electric current, the improvement wherein the valve further comprising a mechanical spring (15), which likewise presses the valve member (10) in the direction of the valve seat (16), the spring (15) having a spring constant or prestressing designed such that not until a predetermined minimum fuel pressure is an injection event, with a quantity of fuel sufficient for emergency vehicle operation, possible.
